(19) United States
(12) Patent Application Publication
(10) Pub. No.: US 2009/0062980 A1
(43) Pub. Date: Mar. 5, 2009

(54) VEHICULAR POSTURE ESTIMATION DEVICE AND VEHICULAR POSTURE ESTIMATION METHOD

(75) Inventors: Kazunori Kanai, Wako-shi (JP); Yukinobu Nakamura, Wako-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/196,045

(22) Filed: Aug. 21, 2008

(30) Foreign Application Priority Data
Aug. 27, 2007 (JP) 2007-220029

(51) Int. Cl. G06F 17/00

(52) U.S. Cl. 701/33

(57) ABSTRACT

The present invention provides a vehicular posture estimation device for estimating a posture of a vehicle, including: a first processor, which determines a vehicular velocity, a roll axial component of a vehicular acceleration in a roll axis and a pitch axial component of the vehicular acceleration in a pitch axis and an angular velocity around a yaw axis in a vehicular coordinate system of the vehicle; and a second processor, which calculates the posture of the vehicle according to a composite operator of a first operator representing a rotation of a global coordinate system for matching a Z axis of the global coordinate system to the yaw axis, and a second operator representing the rotation of the global coordinate for matching an X axis and Y axis of the global coordinate system to the roll axis and pitch axis of the vehicular coordinate system, respectively, on the basis of a determination result from the first processor.

### BACKGROUND OF THE INVENTION

1. Field of the Invention

The present invention relates to a vehicular posture estimation device and a vehicular posture estimation method.

2. Description of the Related Art

There has been disclosed, for example, in Japanese Patent Laid-open No. 9-42979, an art for displaying accurately a vehicular position of a vehicle on a map in a navigation device, which attempts to improve a determination accuracy of the vehicular position by getting rid of effects caused by a road inclination through calculating an inclined angle of the road where the vehicle is running on the basis of an output from a vehicular velocity sensor and a 3-axis acceleration sensor, respectively, and thereafter correcting an output from a gyro sensor on the basis of the inclined angle calculated.

However, according to the conventional art, a posture of a vehicle is obtained on determination results of a vehicular velocity, a 3-axis vehicular acceleration and a 1-axis angular velocity. A 3-axis acceleration sensor which is used to obtain the determination result of the 3-axis vehicular acceleration is very expensive. Therefore, the conventional art is disadvantageous from the viewpoint of cost.

### SUMMARY OF THE INVENTION

The present invention has been accomplished in view of the aforementioned problem, and it is therefore an objective of the present invention to provide a vehicular posture estimation device which estimates in high accuracy a posture of a vehicle by reducing the numbers of parameters representing a vehicular behavior, which serves as a determination object, so as to use a 2-axis acceleration sensor, which is relatively cheap.

The vehicular posture estimation device according to a first aspect of the present invention includes: a first processor, which determines a vehicular velocity, a roll axial component of a vehicular acceleration in a roll axis and a pitch axial component of the vehicular acceleration in a pitch axis, and an angular velocity around a yaw axis in a vehicular coordinate system of the vehicle; and a second processor, which calculates the posture of the vehicle according to a composite operator of a first operator representing a rotation of a global coordinate system for matching a Z axis of the global coordinate system to the yaw axis, and a second operator representing the rotation of the global coordinate for matching an X axis and Y axis of the global coordinate system to the roll axis and pitch axis of the vehicular coordinate system, respectively, on the basis of a determination result from the first processor.

According to the first aspect of the present invention, the vehicular velocity, the 2-axis (the roll axis and the pitch axis) acceleration and the angular velocity around 1-axis (the yaw axis) are determined as parameters representing a vehicular behavior. In other words, in comparison to the conventional art, the determination of the 1-axis (the yaw axis) acceleration is unnecessary in the present invention; thereby the numbers of the determination objects can be reduced. Thereafter, the posture of the vehicle in the global coordinate system is estimated according to the composite operator of the first operator representing the rotation of the global coordinate system for matching the Z axis of the global coordinate system to the yaw axis of the vehicular coordinate system, and the second operator representing the rotation of the global coordinate for matching the X axis and Y axis of the global coordinate system to the roll axis and pitch axis of the vehicular coordinate system, respectively, on the basis of the determination result from the first processor. According thereto, the vehicular posture in the global coordinate system can be estimated in high accuracy by reducing the numbers of parameters representing a vehicular behavior, which serves as the determination object, so as to use a 2-axis acceleration sensor, which is relatively cheap.

The vehicular posture estimation device according to a second aspect of the present invention is dependent on the first aspect of the present invention, wherein the second processor calculates, as a first posture, a posture of the yaw axis in the vehicular coordinate system with respect to the Z axis of the global coordinate system according to the first operator, on the basis of the vehicular velocity and the roll axial component of the vehicular acceleration and the angular velocity around the yaw axis of the vehicle among the determination result from the first processor; and calculates, as a second posture, a posture of the roll axis of the vehicular coordinate system with respect to the X axis of the global coordinate system and a posture of the pitch axis of the vehicular coordinate system with respect to the Y axis of the global coordinate system in a state where the yaw axis and the Z axis match each other according to the second operator, on the basis of the first posture, the vehicular velocity and the roll axial component of the vehicular acceleration and the angular velocity around the yaw axis of the vehicle among the determination result from the first processor.

According to the vehicular posture estimation device of the second aspect of the present invention, the second posture may be calculated as the vehicular posture in the global coordinate system on the basis of the first posture which is calculated previously.

The vehicular posture estimation device according to a third aspect of the present invention is dependent on the first aspect of the present invention, wherein the second processor calculates the posture of the vehicle according to a quaternion which serves as the first operator and the second operator.

According to the vehicular posture estimation device of the third aspect of the present invention, it is possible to calculate in high accuracy the vehicular posture by adopting the quaternion to reduce the processing amount of the second processor.

The vehicular posture estimation method according to a fourth aspect of the present invention includes: a first processing, which determines a vehicular velocity, a roll axial component of a vehicular acceleration in a roll axis and a pitch axial component of the vehicular acceleration in a pitch axis, and an angular velocity around a yaw axis in a vehicular coordinate system of the vehicle; and a second processing, which calculates the posture of the vehicle according to a composite operator of a first operator representing a rotation of a global coordinate system for matching a Z axis of the global coordinate system to the yaw axis, and a second operator representing the rotation of the global coordinate for matching an X axis and Y axis of the global coordinate system to the roll axis and pitch axis of the vehicular coordinate system, respectively, on the basis of a determination result from the first processing.

According to the vehicular posture estimation method of the fourth aspect of the present invention, the vehicular posture in the global coordinate system can be estimated in high accuracy while reducing the numbers of parameters representing a vehicular behavior, which serves as the determination object, less than that in the conventional art.

### BRIEF DESCRIPTION OF THE DRAWINGS

FIG. 1 is an explanatory diagram illustrating a configuration of a vehicular posture estimation device.

FIG. 2 is a block chart illustrating a configuration of the vehicular posture estimation device.

FIG. 3 is a flow chart illustrating a vehicular posture estimation method.

FIGS. 4(a) to 4(c) are explanatory diagrams illustrating a relation between a global coordinate system and a vehicular coordinate system, respectively.

FIG. 5 is an explanatory diagram illustrating correction on a yaw rate.

### DETAILED DESCRIPTION OF THE PREFERRED EMBODIMENTS

Hereinafter, an embodiment for a vehicular posture estimation device and a vehicular posture estimation method of the present invention will be described with reference to the drawings.

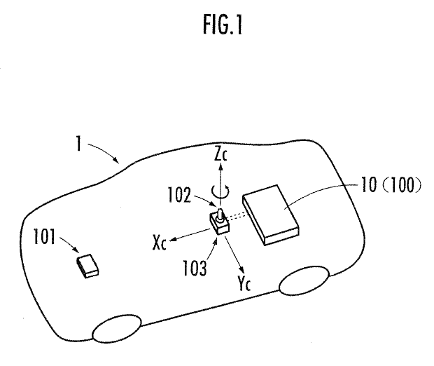

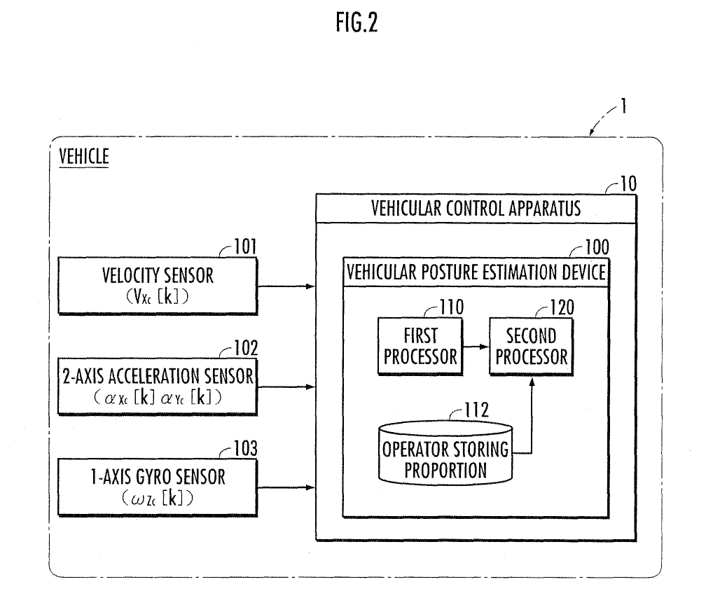

As illustrated in FIGS. 1 and 2, a vehicle 1 is mounted with a vehicular control apparatus 10, a velocity sensor 101, a 2-axis acceleration sensor 102, and a 1-axis gyro sensor 103. The vehicular control apparatus 10 is provided with a vehicular posture estimation device 100 which includes a first processor 110, an operator storing portion 112, and a second processor 120.

In the description, a parameter with a subscript “g” represents a parameter in a global coordinate system; similarly, a parameter with a subscript “c” represents a parameter in a vehicular coordinate system.

The velocity sensor 101 outputs an output signal according to a velocity v_{xc}[k] in a roll axial direction (x_{c} direction) in the vehicular coordinate system of the vehicle 1. The 2-axis acceleration sensor 102 outputs an output signal according to a roll axial component (component in x_{c} direction) α_{xc}[k] and a pitch axial component (component in y_{c} direction) α_{yc}[k] of an acceleration α in the vehicular coordinate system of the vehicle 1. The 1-axis gyro sensor 103 outputs an output signal according to an angular velocity ω_{zc}[k] around a yaw axis (z_{c} axis) in the vehicular coordinate system of the vehicle 1.

The first processor 110 determines the velocity v_{xc}[k] in the roll direction, the roll axial component α_{xc}[k] and the pitch axial component α_{yc}[k] of the acceleration α, and the angular velocity ω_{zc}[k] around the yaw axis of the vehicle 1, on the basis of the respective output signal from the velocity sensor 101, the 2-axis acceleration sensor 102 and the 1-axis gyro sensor 103. The second processor 120 estimates a posture of the vehicle 1 in the global coordinate system according to a first operator and a second operator stored in the operator storing portion 112 on the basis of the determination result by the first processor 110.

Hereinafter, descriptions will be given on a vehicular posture estimation method performed by the vehicular posture estimation device with the aforementioned configuration of the vehicle 1.

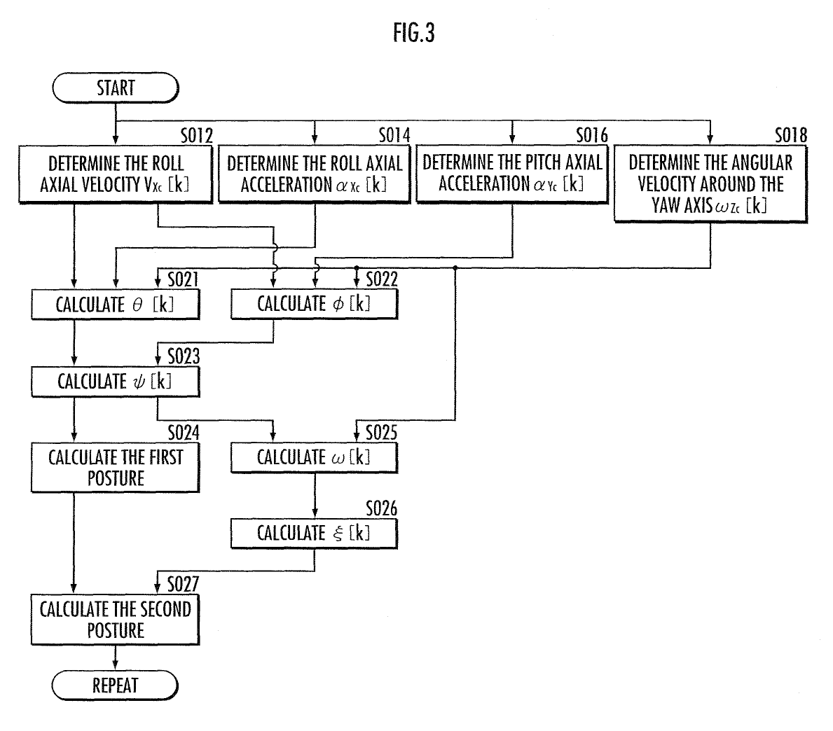

Firstly, the first processor 110 performs a first processing which determines a parameter representing a behavior of the vehicle 1. Specifically, the first processor 110 determines the roll axial velocity v_{xc}[k] of the vehicle 1 at the timing k on the basis of the output signal from the velocity sensor 101 (FIG. 3/S012). The first processor 110 determines the roll axial component α_{xc}[k] of the acceleration α at the timing k (FIG. 3/S014) and the pitch axial component α_{yc}[k] of the acceleration α at the timing k (FIG. 3/S016) on the basis of the output signal from the 2-axis acceleration sensor 102. The first processor 110, on the basis of the output signal from the 1-axis gyro sensor 103, determines the angular velocity ω_{zc}[k] around the yaw axis of the vehicle 1 at the timing k (FIG. 3/S018).

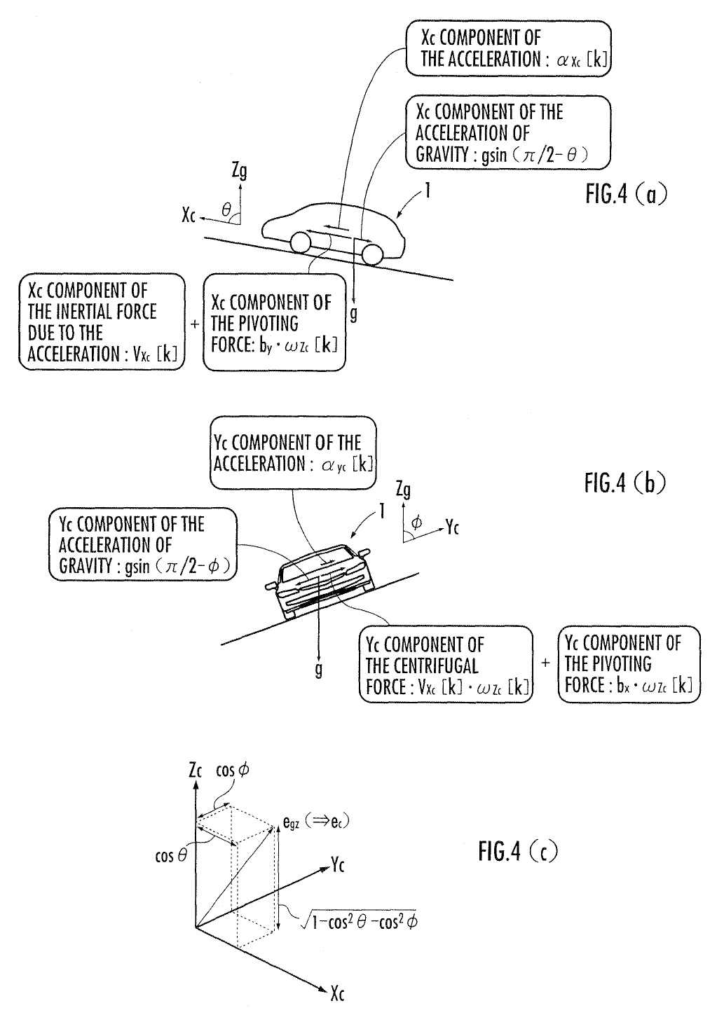

Subsequently, the second processor 120, on the basis of the determination results obtained by the first processor 110, performs a second processing which estimates a posture of the vehicle 1 in the global coordinate system. Specifically, the second processor 120 calculates an inclination angle θ[k] in the x_{c} direction of the vehicular coordinate system with respect to the z_{g} direction of the global coordinate system at the timing k (FIG. 3/S021). The inclination angle θ[k] is calculated according to the equation (1) on the basis of the roll axial component α_{xc}[k] of the acceleration α of the vehicle 1 at the timing k, a temporal variation rate v_{xc}′[k] of the roll axial velocity v_{xc}[k] of the vehicle 1 at the timing k, a distance l_{y} in y direction from a pivoting point to the 1-axis gyro sensor 103, and a temporal variation rate ω_{zc}′[k] of the angular velocity ω_{zc}[k] around the yaw axis (yaw rate) at the timing k. There is expressed in the equation (1) that the x_{c} directional component α_{xc}[k] of the acceleration α of the vehicle 1, as illustrated in FIG. 4(a), is equal to a sum of a x_{c} directional component of the gravity, the centrifugal force, and the inertial force and the pivoting force due to acceleration and deceleration, respectively (herein, the x_{c} directional component of the centrifugal force is zero).

θ=π/2−arcsin((α_{xc}[k]−V_{xc}′[k]−l_{y}·ω_{zc}′[k])/g)

v_{zc}′[k]=(v_{xc}[k]−v_{xc}[k−1])/Δt

ω_{zc}′[k]=(ω_{zc}[k]−ω_{zc}[k−1])/Δt (1)

Thereafter, the second processor 120 calculates an inclination angle θ[k] in the y_{c} direction in the vehicular coordinate system with respect to the z_{g} direction in the global coordinate system at the timing k (FIG. 3/S022). The inclination angle θ[k] is calculated according to the equation (2) on the basis of the y directional component α_{yc}[k] of the acceleration α of the vehicle 1 at the timing k, the x directional component v_{xc}[k] of the vehicle 1 at the timing k, a distance lₓ in the x direction from the pivoting point to the 1-axis gyro sensor 103, the yaw rate ω_{xc}[k] at the timing k, and a temporal variation rate ω′_{zc}[k] of the yaw rate ω_{zc}[k] at the timing k. There is expressed in the equation (2) that the y_{c} directional component α_{yc}[k] of the acceleration α of the vehicle 1, as illustrated in FIG. 4(b), is equal to a sum of a y_{c} directional component of the gravity, the centrifugal force, and the inertial force and the pivoting force due to acceleration and deceleration, respectively (herein, the y_{c} directional component of the inertial force due to the acceleration and deceleration is zero).

φ=π/2−arcsin((α_{yc}[k]−v_{xc}[k]·ω_{zc}[k]−lₓ·ω_{zc}′[k])/g) (2)

Next, the second processor 120 calculates an inclination angle ψ[k] in the z_{c} direction in the vehicular coordinate system with respect to the z_{g} direction in the global coordinate system at the timing k (FIG. 3/S023). The inclination angle ψ[k] is calculated on the basis of a geometrical relationship illustrated in FIG. 4(c). Specifically, the z_{c} directional inclination angle ψ[k] is calculated according to the equation (3), on the basis of the x_{c} directional inclination angle θ[k] and the y_{c} directional inclination angle θ[k] of the vehicular coordinate system with respect to the z_{g} direction in the global coordinate system at the timing k, respectively.

ψ[k]=arcsin \sqrt{cos²θ[k]+cos²θ[k]} (3)

Subsequently, the second processor 120 calculates a first posture pt₁ᵢ[k] (i=x_{c}, y_{c}, z_{c}) of the vehicle 1 according to the equation (4), on the basis of the above calculation results based on the determination results of the first processor 110 and a first quaternion qt₁[k] which is stored in the operator storing portion 112 as the first operator (FIG. 3/S024).

pt₁ᵢ[k]≡qt₁*[k]·ptᵢ[0]·qt₁[k],

pt_{zc}[0]=(1,0,0,0),pt_{yc}[0]=(0,1,0,0),pt_{zc}[0]=(0,0,1,0) (4)

The first quaternion qt₁[k] represents the rotation of the z_{g} axis in the global coordinate system for matching the z_{g} axis in the global coordinate system with the z_{c} axis in the vehicular coordinate system. The rotation rotates around a unit normal vector n=(nₓ, n_{y}, n_{z}) of a plane containing the z_{g} axis of the global coordinate system and the z_{c} axis of the vehicular coordinate system. The first quaternion qt₁[k] is expressed in the equation (5) on the basis of the inclination angle ψ[k] in the z_{c} direction of the vehicular coordinate system with respect to the z_{g} direction of the global coordinate system at the timing k.

$$\begin{matrix}{qt}_{1} [ k ] ≡ ( {qt}_{1 x} [ k ] , {qt}_{1 y} [ k ] , {qt}_{1 z} [ k ] , {qt}_{1 w} [ k ] ) \\ = ( {n}_{x} [ k ] sin ( ψ [ k ] / 2 ) , {n}_{y} [ k ] sin ( ψ [ k ] / 2 ) , \\ ( {n}_{z} [ k ] sin ( ψ [ k ] / 2 ) , cos ( ψ [ k ] / 2 ) )\end{matrix} \qquad ( 5 )$$

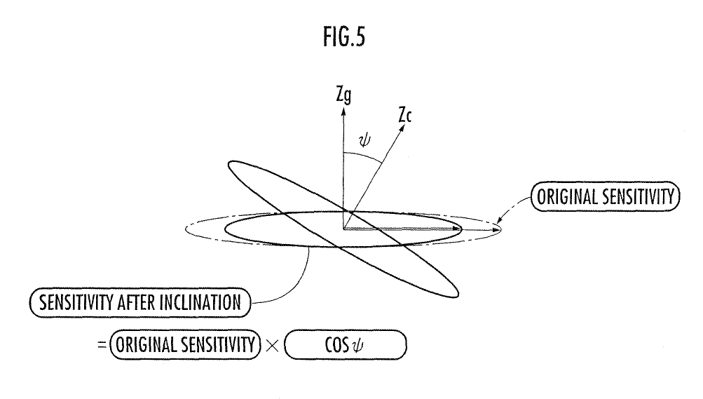

Further, the second processor 120 calculates a yaw rate ω[k] around the z_{g} axis of the vehicle 1 in the global coordinate system (FIG. 3/S025). As illustrated in FIG. 5, if the yaw axis or the z_{c} direction of the vehicular coordinate system is inclined at the inclination angle ψ[k] from the z_{g} direction of the global coordinate system, the sensitivity of the 1-axis gyro sensor 103 is reduced by cos ψ[k]. Thereby, the (original) yaw rate ω[k] around the z_{g} axis of the vehicle 1 in the global coordinate system is obtained by correcting the yaw rate ω_{xc}[k] around the z_{c} axis which is related to the output of the 1-axis gyro sensor 103 on the basis of the z_{c} directional inclination angle ψ[k] of the vehicular coordinate system with respect to the z_{g} direction in the global coordinate system according to the equation (6).

ω[k]=ω_{zc}[k]/cos ψ[k] (6)

Thereafter, the second processor 120 calculates an inclination angle ζ[k] in the xc direction in the vehicular coordinate system with respect to the x_{g} direction in the global coordinate system at the timing k (FIG. 3/S026). The inclination angle ζ[k] is calculated according to the equation (7), on the basis of the inclination angle ζ[k−1] at a previous timing “k−1” (ζ[0]=0), and the angular velocity ω[k] of the vehicle 1 at the timing k.

ζ[k]=ζ[k−1]+ω[k]·Δt (7)

Subsequently, the second processor 120 calculates a second posture pt₂ᵢ[k] (i=x_{c}, y_{c}, z_{c}) according to the equation (8), on the basis of the above calculation results in regard to the first posture or the like based on the determination result of the first processor 110, and a second quaternion qt₂ [k] stored in the operator storing portion 112 as the second operator (FIG. 3/S028).

$$\begin{matrix}{pt}_{2 i} [ k ] ≡ {qt}_{2}^{*} [ k ] \cdot {pt}_{1 i} [ 0 ] \cdot {qt}_{2} [ k ] \\ = {q t}_{2}^{*} [ k ] \cdot {qt}_{1}^{*} [ k ] \cdot {pt}_{i} [ 0 ] \cdot {qt}_{1} [ k ] \cdot {qt}_{2} [ k ]\end{matrix} \qquad ( 8 )$$

The second quaternion qt₂[k] represents the rotation of the global coordinate system for matching the x_{g} axis and the y_{g} axis in the global coordinate system with the x_{c} axis and y_{c} axis in the vehicular coordinate system, respectively. The rotation rotates around a unit vector (0, 0, 1) in the z_{g} direction of the global coordinate system. The second quaternion qt₂[k] is expressed in the equation (9) on the basis of the inclination angle ζ[k] in the x_{c} direction of the vehicular coordinate system with respect to the x_{g} direction of the global coordinate system at the timing k.

$$\begin{matrix}{qt}_{2} [ k ] ≡ ( {qt}_{2 x} [ k ] , {qt}_{2 y} [ k ] , {qt}_{2 z} [ k ] , {qt}_{2 w} [ k ] ) \\ = ( 0 , 0 , sin ( ξ [ k ] / 2 ) , cos ( ξ [ k ] / 2 ) )\end{matrix} \qquad ( 9 )$$

Thereafter, the calculation result of the second posture pt₂ᵢ[k] is estimated as the posture of the vehicle 1 in the global coordinate system at the timing k.

According to the vehicular posture estimation device having the above-mentioned functions, the velocity v_{xc}[k], the 2-axis acceleration ((α_{xc}[k] and α_{yc}[k]), and the angular velocity ω_{zc}[k] around one axis (the yaw axis) of the vehicle 1 can be determined as parameters representing the behavior of the vehicle 1. Specifically, according to the vehicular posture estimation device of the present invention, the numbers of the determination objects can be reduced less than that in the conventional arts by omitting the determination, which is unnecessary, on the acceleration α_{zc}[k] along one axis (the yaw axis) (refer to FIG. 3/S012, S014, S016 and S018). Further, on the basis of the determination results, the posture of the vehicle 1 in the global coordinate system is estimated according to the composite operator of the first quaternion qt₁[k] representing the rotation of the global coordinate system for matching the z axis of the global coordinate system with the yaw axis of the vehicular coordinate system and the second quaternion qt₂[k] representing the rotation of the global coordinate system for matching the x axis and y axis of the global coordinate system with the roll axis and the pitch axis of the vehicular coordinate system, respectively (refer to FIG. 3/S021 to S028). Therefore, the vehicular posture estimation device of the present invention can estimate in high accuracy the posture of the vehicle 1 by reducing the numbers of parameters representing the behavior of the vehicle 1, which serves as a determination object, so as to use a 2-axis acceleration sensor, which is relatively cheaper than the 3-axis acceleration sensor.

In the above embodiment, the second posture pt₂ᵢ[k] is calculated on the basis of the first posture pt₁ᵢ[k] which is calculated previously (FIG. 3/S024 and S027); however, it is also acceptable to estimate the posture of the vehicle 1 by using a matrix instead of a quaternion as the operator according to a composite quaternion qt[k]=qt₁[k]·qt₂[k] of the first quaternion qt₁[k] and the second quaternion qt₂ [k]. Specifically, the posture P[k] of the vehicle 1 at the timing k is estimated according to the equation (10) by using a first rotation matrix Q₁[k] and a second rotation matrix Q₂[k].

P[k]≡[Pₓ[k],P_{Y}[k],P_{z}[k]]=Q₂[k]Q₁[k]P[0]

Pₓ[k]=^{t}(Pₓ₁[k],Pₓ₂[k],Pₓ₃[k]),P_{y}[k]=^{t}((P_{y1}[k],P_{y2}[k],P_{y3}[k]),P_{z}[k]=^{t}(P_{z1}[k],P_{z2}[k],P_{z3}[k])

Pₓ[0]=^{t}(1,0,0),P_{y}[0]=^{t}(0,1,0),P_{z}[0]=^{t}(0,0,1) (10)

The first rotation matrix Q₁[k] representing the rotation around the y_{g} axis of the global coordinate system for matching the z_{g} axis of the global coordinate system with the z_{c} axis of the vehicular coordinate system, is expressed by the equation (11).

Q₁[k]≡[Q₁₁[k],Q₁₂[k],Q₁₃[k]],

Q₁₁=^{t}(1−2(qt_{1y}²+qt_{1z}²),2(qt₁ₓqt_{1y}−qt_{1z}qt_{1w}),2(qt_{1z}qt₁ₓ+qt_{1w}qt_{1y})),

Q₁₂=^{t}(2(qt₁ₓqt_{1y}+qt_{1z}qt_{1w}),1−2(qt_{1z}²+qt₁ₓ²),2(qt_{1y}qt_{1z}−qt_{1w}qt₁ₓ)),

Q₁₃=^{t}(2(qt_{1z}qt₁ₓ−qt_{1w}qt_{1y}),2(qt_{1y}qt_{1z}+qt_{1w}qt₁ₓ)1−2(qt₁ₓ²+qt_{1y}²)) (11)

The second rotation matrix Q₂[k] representing the rotation around the z_{g} axis of the global coordinate system for matching the x_{g} axis and the y_{g} axis of the global coordinate system with the x_{c} axis and the y_{c} axis of the vehicular coordinate system, respectively, is expressed by the equation (12) on the basis of the inclined angle ζ[k] in the x_{c} direction in the vehicular coordinate system with respect to the x_{g} direction in the global coordinate system at the timing k.

Q₂[k]≡[Q₂₁[k],Q₂₂[k],Q₂₃[k]],

Q₂₁[k]=^{t}(cos ζ[k],−sin ζ[k],0),Q₂₂[k]=^{t}(sin ζ[k],cos ζ[k],0),Q₂₃[k]=^{t}(0,0,1) (12)

According to the present embodiment, similar to that in the previous embodiment, the posture of the vehicle 1 can be estimated in high accuracy by reducing the numbers of parameters representing the behavior of the vehicle 1, which serve as the determination object, so as to use a 2-axis acceleration sensor, which is relatively cheaper than the 3-axis acceleration sensor.

Although the present invention has been explained in relation to the preferred embodiments and drawings but not limited, it should be noted that other possible modifications and variations made without departing from the gist and scope of the invention will be comprised in the present invention. Therefore, the appended claims encompass all such changes and modifications as falling within the gist and scope of the present invention.

What is claimed is:

1. A vehicular posture estimation device for estimating a posture of a vehicle, comprising:
a first processor, which determines a vehicular velocity, a roll axial component of a vehicular acceleration in a roll axis and a pitch axial component of the vehicular acceleration in a pitch axis, and an angular velocity around a yaw axis in a vehicular coordinate system of the vehicle; and
a second processor, which calculates the posture of the vehicle according to a composite operator of a first operator representing a rotation of a global coordinate system for matching a Z axis of the global coordinate system to the yaw axis, and a second operator representing the rotation of the global coordinate for matching an X axis and Y axis of the global coordinate system to the roll axis and pitch axis of the vehicular coordinate system, respectively, on the basis of a determination result from the first processor.

2. The vehicular posture estimation device according to claim 1, wherein the second processor calculates a posture of the yaw axis in the vehicular coordinate system with respect to the Z axis of the global coordinate system as a first posture according to the first operator, on the basis of the vehicular velocity and the roll axial component of the vehicular acceleration and the angular velocity around the yaw axis of the vehicle among the determination results from the first processor; and calculates a posture of the roll axis of the vehicular coordinate system with respect to the X axis of the global coordinate system and a posture of the pitch axis of the vehicular coordinate system with respect to the Y axis of the global coordinate system in a state where the yaw axis and the Z axis match each other as a second posture according to the second operator, on the basis of the first posture, the vehicular velocity and the roll axial component of the vehicular acceleration and the angular velocity around the yaw axis of the vehicle among the determination results from the first processor.

3. The vehicular posture estimation device according to claim 1, wherein the second processor calculates the posture of the vehicle according to a quaternion which serves as the first operator and the second operator.

4. A vehicular posture estimation method for estimating a posture of a vehicle, comprising:
a first processing, which determines a vehicular velocity, a roll axial component of a vehicular acceleration in a roll axis and a pitch axial component in a pitch axis, and an angular velocity around a yaw axis in a vehicular coordinate system of the vehicle; and
a second processing, which calculates the posture of the vehicle according to a composite operator of a first operator representing a rotation of a global coordinate system for matching a Z axis of the global coordinate system to the yaw axis, and a second operator representing the rotation of the global coordinate for matching an X axis and Y axis of the global coordinate system to the roll axis and pitch axis of the vehicular coordinate system, respectively, on the basis of a determination results from the first processing.
